(19) United States
(12) Patent Application Publication
(10) Pub. No.: US 2021/0038021 A1
(43) Pub. Date: Feb. 11, 2021

(54) STOKER/GRILL COMBINATION

(71) Applicant: INDUSTRO INTERNATIONAL CO., LTD., Taichung (TW)

(72) Inventor: KUO-CHAN HUANG, Taichung (TW)

(21) Appl. No.: 16/532,484

(22) Filed: Aug. 6, 2019

(51) Int. Cl. A47J 37/07

(52) U.S. Cl. CPC A47J 37/07

(57) ABSTRACT

A stoker/grill combination includes a stoker, a burner-supporting element and a burner. The stoker includes panels connected to one another to provide a cylindrical configuration and a group of assembling apertures in at least some of the panels. The burner-supporting element includes two terminal sections. The terminal sections are inserted in the group of assembling apertures to connect the burner-supporting element to the panels. The burner is supported on the terminal sections of the burner-supporting element.

### BACKGROUND OF INVENTION

### 1. Field of Invention

The present invention relates to a grill and, more particularly, to a combination of a stoker with a grill.

### 2. Related Prior Art

A person has to start a fire before enjoying barbecue. For example, kindling (or “tinder”) is laid amid charcoal before the kindling is ignited to start a fire that is expected to ignite the charcoal to increase the fire. However, the fire caused by the ignition of the kindling is small, and it takes a long period of time for the fire to ignite the charcoal.

Alternatively, a flame sprayer is used to ignite charcoal in a bowl of a grill. The charcoal could be ignited by a flame spit from the flame sprayer in a short period of time. However, the flame sprayer does not only ignite the charcoal but also blows ash everywhere. The ash could contaminate food in or around the grill so that the food is not delicious or healthy.

The flame sprayer can be used with a stoker such as the one disclosed in Taiwanese Patent 1590792 issued to the present inventor. The flame sprayer is used to ignite charcoal in the stoker before the ignited charcoal is poured into a grill from the stoker. Such pouring is however troublesome.

The present invention is therefore intended to obviate or at least alleviate the problems encountered in prior art.

### SUMMARY OF INVENTION

It is the primary objective of the present invention to provide a combination of a stoker with a grill.

To achieve the foregoing objective, the stoker/grill combination includes a stoker, a burner-supporting element and a burner. The stoker includes panels connected to one another to provide a cylindrical configuration and a group of assembling apertures in at least some of the panels. The burner-supporting element includes two terminal sections. The terminal sections are inserted in the group of assembling apertures to connect the burner-supporting element to the panels. The burner is supported on the terminal sections of the burner-supporting element.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a stoker/grill combination according to the preferred embodiment of the present invention;

FIG. 2 is a perspective view of a stoker of the stoker/grill combination shown in FIG. 1;

FIG. 3 is a cross-sectional view of the stoker shown in FIG. 2;

FIG. 4 is a perspective view of the stoker/grill combination shown in FIG. 1 without a grid;

FIG. 5 is a perspective view of the stoker/grill combination shown in FIG. 1; and

FIG. 6 is a cross-sectional view of a kettle on the stoker/grill combination shown in FIG. 5.

### DETAILED DESCRIPTION OF PREFERRED EMBODIMENT

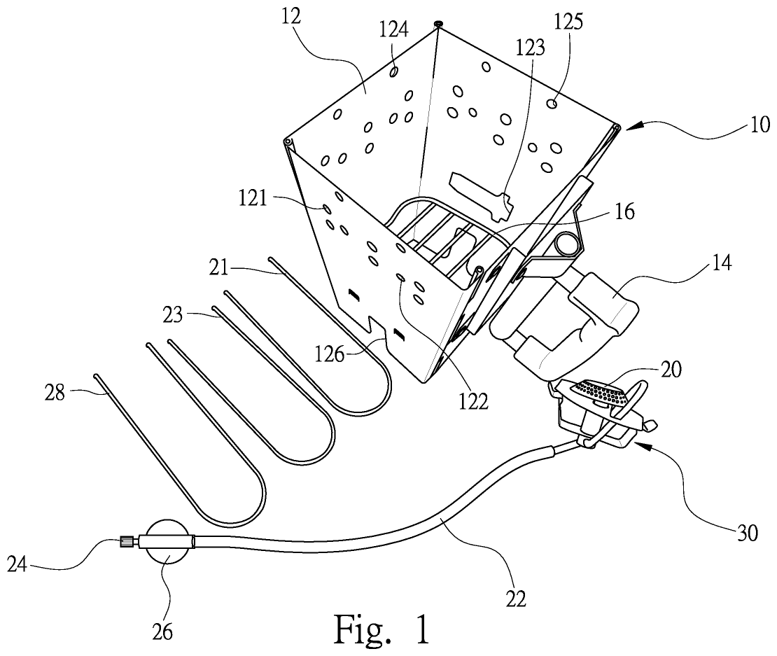

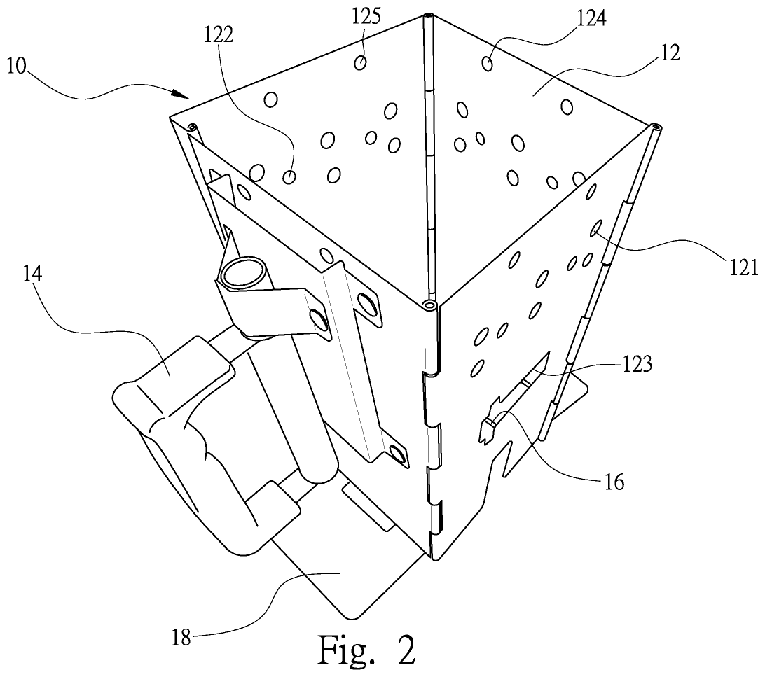

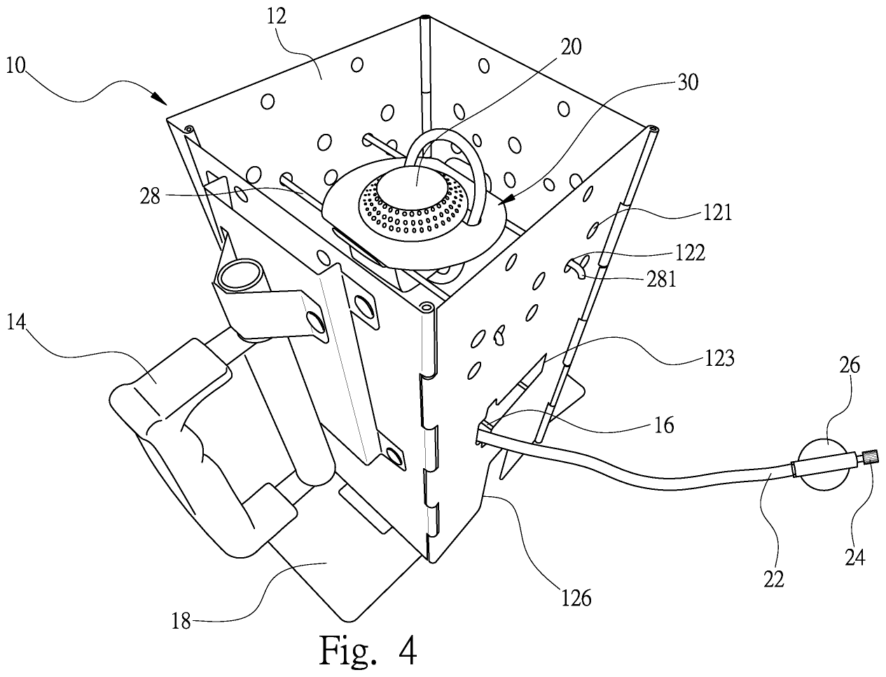

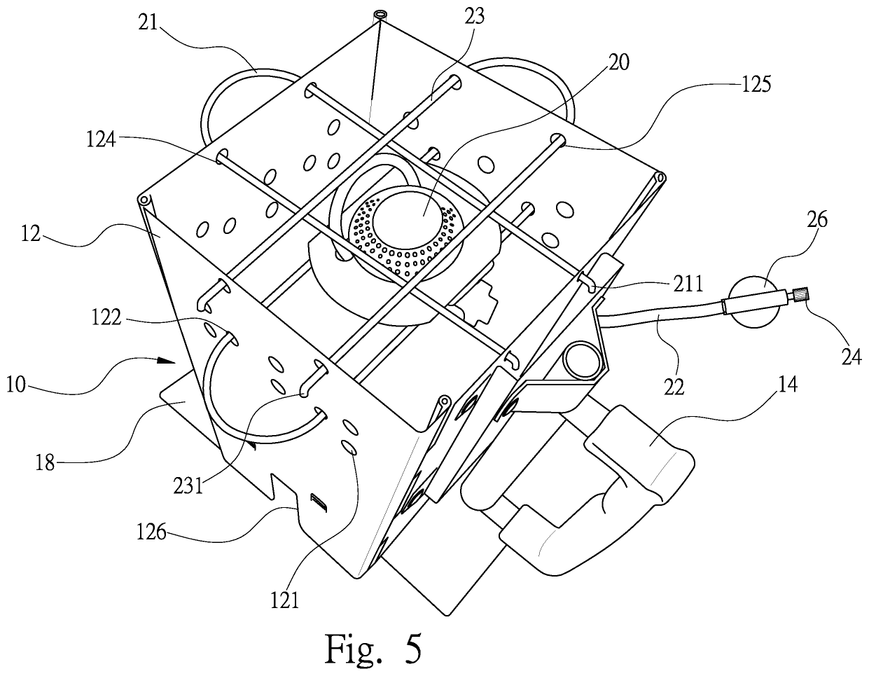

Referring to FIGS. 1 through 6, a stoker/grill combination includes a stoker 10, a grid (not numbered) and a burner device (not numbered) according to the preferred embodiment of the present invention. In a first mode of the stoker/grill combination, the grid is not connected to the stoker 10. The burner device is used to ignite charcoal in, and then the burned charcoal is moved into a grill from the stoker/grill combination. In a second mode of the stoker/grill combination, the grid is connected to the stoker 10, and the burner device is used to cook food on the grid.

The stoker 10 includes four panels 12, a handle 14, a charcoal grid 16 and two bottom plates 18. The panels 12 are pivotally connected to one another by hinges (not numbered) so that the stoker 10 is moveable between an extended position as shown in the drawings and a collapsed position (not shown).

The handle 14 is connected to an external face of one of the panels 12. The handle 14 is operable to move the stoker 10.

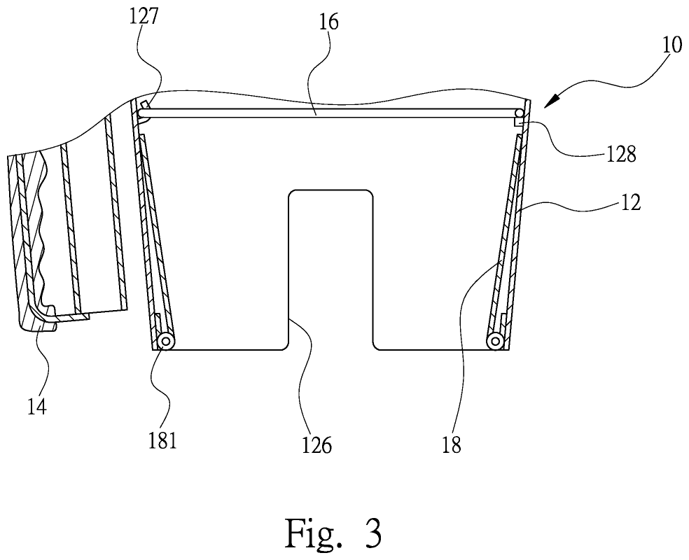

Referring to FIG. 3, two hooks 127 are formed on an internal face of one of the panels 12. Two bosses 128 are formed on an internal face of an opposite one of the panels 12. The charcoal grid 16 is inserted in and connected to the stoker 10 if necessary. In such a case, a portion of the charcoal grid 16 is hooked by the hooks 127, and an opposite of the charcoal grid 16 is supported on the bosses 128.

One of the bottom plates 18 is pivotally connected to the internal face of one of the panels 12 by two hinges 181, and the remaining one of the bottom plates 18 is pivotally connected to the internal face of an opposite one of the panels 12 by two other hinges 181. In the collapsed position of the stoker/grill combination, the bottom plates 18 are located against the internal faces of the panels 12 so that the bottom plates 18 are concealed in the stoker 10. In the extended position of the stoker/grill combination, the bottom plates 18 extend perpendicular to the panels 12 to occupy a large area to facilitate stable location of the stoker 10 on a floor.

In the first mode, the charcoal is laid on the charcoal grid 16 via an upper open end of the stoker 10. A nozzle of a flame sprayer (not shown) is inserted in the stoker 10 via an ignition bore 126 made in a lower portion of one of the panels 12. The flame sprayer is used to send a flame out of the nozzle. The flame ignites the charcoal on the charcoal grid 16. Then, the handle 14 is operated to move the stoker 10 to the grill and then the ignited charcoal is poured into the grill from the stoker 10.

The stoker 10 further includes vents 121, assembling apertures 122, 124, 125 and an opening 123 made in the panels 12. The opening 123 and the assembling apertures 122, 124, 125 can be used like the vents 121. Other functions of the opening 123 and the assembling apertures 122, 124, 125 will be described later.

The burner device includes a burner 20, a pipe 22, a knob 24, a valve 26 and a burner-supporting element 28. The pipe 22 includes an end connected to the burner 20 and another end connected to the valve 26. In use, the valve 26 is connected to a gas tank for example. The knob 24 is connected to the valve 26. The knob 24 is operable to move the valve 26 between an open position and a closed position. The burner 20 is inserted in the stoker 10. The valve 26 is moved out of the stoker 10 via the opening 123.

The burner-supporting element 28 is made of a metal bar and includes an arched intermediate section (not numbered) formed between two terminal sections 282 that extend parallel to each other. Each of the terminal sections 282 is formed with a hook 281 at a free end. The terminal sections 282 are inserted in the assembling apertures 122 so that the burner-supporting element 28 is supported by two of the panels 12 of the stoker 10. The hooks 281 of the burner-supporting element 28 and the intermediate section of the burner-supporting element 28 keep the terminal sections 282 of the burner-supporting element 28 connected to the stoker 10.

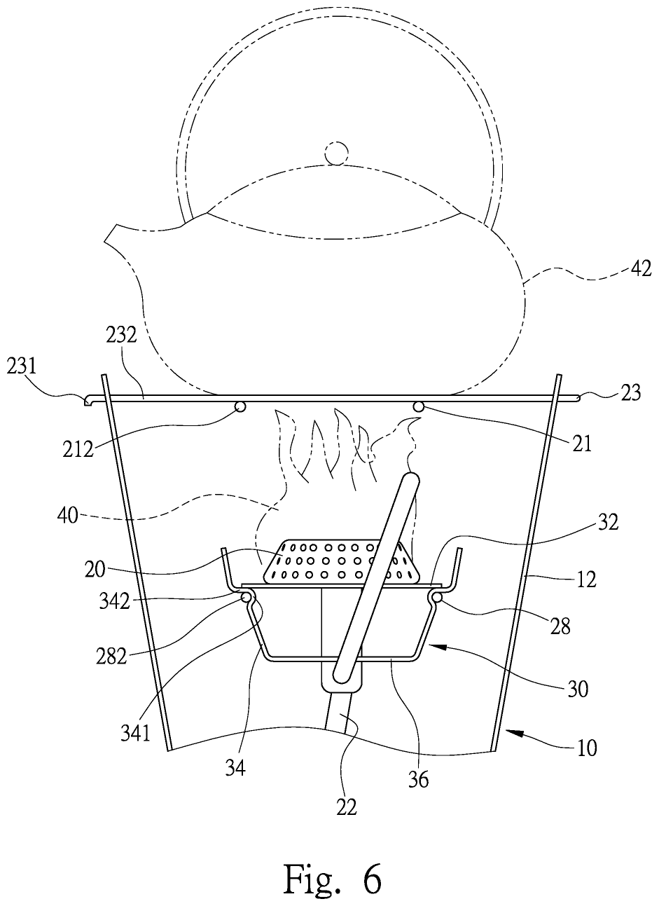

Referring to FIG. 6, a connecting device is used to firmly lay the burner 20 on the burner-supporting element 28. The connecting device includes a connector 30 and a plate 32. The connector 30 includes two elastic leaves 34 extending from an intermediate section 36 in opposite senses of direction. Each of the elastic leaves 34 includes an arched section 341 and a horizontal section 342.

The intermediate section 36 of the connector 30 is located lower than the terminal sections 282 of the burner-supporting element 28. The elastic leaves 34 are pressed against the terminal sections 282 of the burner-supporting element 28. The arched section 341 of each of the elastic leaves 34 receives one of the terminal sections 282 of the burner-supporting element 28. The horizontal section 342 of each of the elastic leaves 34 is supported on one of the terminal sections 282 of the burner-supporting element 28. The plate 32 is supported on the horizontal sections 342 of the elastic leaves 34. The burner 20 is supported on the plate 32. The pipe 22 is inserted in an aperture (not numbered) made in the plate 32 and an aperture (not numbered) made in the intermediate section 36 of the connector to keep the plate 32 on the connector.

The grid includes two U-shaped elements 21 and 23 identical to the burner-supporting element 28 regarding the structure. The U-shaped element 21 includes an intermediate section (not numbered) extending between two terminal sections 212 each of which is formed with a hook 211. The U-shaped element 23 includes an intermediate section (not numbered) extending between two terminal sections 232 each of which is formed with a hook 231.

The terminal sections 212 of the U-shaped element 21 are inserted in the assembling apertures 124 of two of the panels 12. The terminal sections 232 of the U-shaped element 23 are inserted in the assembling apertures 125 of the remaining ones of the panels 12. Thus, the U-shaped element 21 and the U-shaped element 23 are supported by the stoker 10. The terminal sections 212 of the U-shaped element 21 intersect the terminal sections 232 of the U-shaped element 23. The hooks 211 of the U-shaped element 21 retain the U-shaped element 21 on the stoker 10. The hooks 231 of the U-shaped element 23 keep the U-shaped element 23 on the stoker 10.

In the second mode, a container 42 is placed on the grid, which consists of the U-shaped elements 21 and 23. The burner 20 is placed below the grid and actuated to a flame 40 to heat the container 42 located above the burner 20. The container 42 is a kettle as shown. However, the container 42 can be any other proper container such as a pan and a pot that can be firmly supported on the grid.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A stoker/grill combination comprising:
a stoker comprising panels connected to one another to provide a cylindrical configuration and a group of assembling apertures in at least some of the panels;
a burner-supporting element comprising two terminal sections, wherein the terminal sections are inserted in the group of assembling apertures to connect the burner-supporting element to the panels; and
a burner supported on the terminal sections of the burner-supporting element.

2. The stoker/grill combination according to claim 1, further comprising a valve and a pipe for connecting the valve to the burner.

3. The stoker/grill combination according to claim 2, wherein one of the panels comprises an opening via which the valve is placed out of the stoker when the burner is located in the stoker.

4. The stoker/grill combination according to claim 1, further comprising a connecting device to facilitate the supporting of the burner on the burner-supporting element.

5. The stoker/grill combination according to claim 4, wherein the connecting device comprises:
a connector comprising two elastic leaves abutted against the terminal sections of the burner-supporting element and an intermediate section formed between the elastic leaves; and
a plate supported on the elastic leaves, wherein the burner is supported on the plate.

6. The stoker/grill combination according to claim 5, wherein each of the elastic leaves comprises an arched section for holding one of the terminal sections of the burner-supporting element.

7. The stoker/grill combination according to claim 6, wherein each of the elastic leaves further comprises a horizontal section for supporting the plate when the arched sections hold the terminal sections of the burner-supporting element, and the burner is supported on the plate.

8. The stoker/grill combination according to claim 1, wherein each of the terminal sections comprises a hook.

9. The stoker/grill combination according to claim 1, further comprising two U-shaped elements each of which comprises two terminal sections, wherein the stoker further comprises two groups of assembling apertures for receiving the terminal sections of the U-shaped elements respectively, and the terminal sections of one of the U-shaped elements intersect the terminal sections of the remaining one of the U-shaped elements above the burner.

10. The stoker/grill combination according to claim 9, wherein each of the terminal sections comprises a hook.
